(19) United States
(12) Patent Application Publication
(10) Pub. No.: US 2005/0074387 A1
(43) Pub. Date: Apr. 7, 2005

(54) Method for producing chlorosilanes

(76) Inventors: Andreas Bulan, Langenfeld (DE); Rainer Weber, Odenthal (DE); Leslaw Mleczko, Bochum (DE)

Correspondence Address: MCGLEW & TUTTLE, PC, 1 SCARBOROUGH STATION PLAZA, SCARBOROUGH, NY, 10510-0827, US

(21) Appl. No.: 10/380,352

(22) PCT Filed: Sep. 6, 2001
(86) PCT No.: PCT/EP01/10269

(30) Foreign Application Priority Data
Sep. 11, 2000 (DE) 100-44-796.1

(51) Int. Cl. C01B 33/08

(52) U.S. Cl. 423/342

(57) ABSTRACT

The invention relates to a method for producing chlorosilanes using silicon containing homogeneously distributed copper silicide. The invention especially relates to a method for producing trichlorosilane by reacting said silicon with water, silicon tetrachloride and optionally hydrogen chloride.

The present invention relates to a method for producing chlorosilanes on the basis of a special silicon.

Chlorosilanes comprise alkyl chlorosilanes, aryl chlorosilanes and trichlorosilane.

Trichlorosilane HSiCl₃ is a valuable intermediate product for producing, for example, high-purity silicon, dichlorosilane H₂SiCl₂, silane SiH₄ and bonding agents.

High-purity silicon is used versatilely for electronic and photo-voltaic purposes, e.g. in manufacturing solar cells. To produce high-purity silicon, for example metallurgical silicon is converted to gaseous silicon compounds, preferably trichlorosilane, these compounds being purified and subsequently reconverted to silicon.

Trichlorosilane is mainly produced by reacting silicon with hydrogen chloride, or silicon with silicon tetrachloride, hydrogen and, if necessary, hydrogen chloride (Ullmann's Encyclopedia of Industrial Chemistry, 5^{th} ed. (1993), Vol. A24, 4-6). As a rule, silicon is reacted with silicon tetrachloride and hydrogen in the presence of catalysts, and mainly copper catalysts.

As is known from DE 41 04 422 A1, silicon is reacted with silicon tetrachloride and hydrogen in a fluidized bed without using pressure in the presence of copper salts of a low, aliphatic, saturated dicarbon acid, particularly copper oxalate.

It is also known to react silicon with silicon tetrachloride, hydrogen and, if necessary, hydrogen chloride, in the presence of powder copper (Chemical Abstracts CA 101, no. 9576d, 1984) or mixtures of copper metal, metal halogenides and bromides or iodides of iron, aluminum or vanadium (Chemical Abstracts CA 109, no. 57621 b, 1988).

Alkyl and aryl chlorosilanes are important starting materials for the manufacture of silicones and are usually produced according to the Müller-Rochow method which is known to those skilled in the art, by reacting silicon with alkyl and/or aryl chlorides in the presence of copper or copper compounds as catalyst, and promoters which can be added, if necessary.

Chlorosilanes are usually produced in a fluidized bed (Ullmann's Encyclopedia of Industrial Chemistry, 5^{th} ed. (1993), Vol. A24, 4-6). A disadvantage of methods according to the state of the art using copper catalysts and/or catalyst mixtures containing copper is that very often small catalyst particles are carried out of the fluidized bed. As a result, the yield of the desired chlorosilane decreases in the course of the process and new catalyst needs to be introduced into the reactor.

JP 09 235 114 A teaches a method for the production of chlorosilanes, in which silicon particles are used, having copper silicide at least on the particle surface. The particles are produced by metallic silicon powder being homogeneously mixed with copper chloride particles and heated to more than 250° C. in an inert atmosphere.

U.S. Pat. No. 4,314,908 A describes a method for the production of methylchlorosilanes by reaction of silicon. To this end, silicon is used, having spots of a copper-silicon alloy substantially uniformly distributed on the surface of the silicon particles.

Therefore the task was to provide a method for producing chlorosilanes in which no large amounts of catalyst are carried out undesiredly.

Surprisingly it was found that when using a silicon containing homogeneously distributed copper silicide, the reaction of this silicon with hydrogen, silicon tetrachloride and, if necessary, hydrogen chloride, to form trichlorosilane and/or with alkyl or aryl halides to form alkyl and/or aryl chlorosilane is catalysed sufficiently without introducing additional catalyst.

Subject-matter of the invention is therefore a method for producing chlorosilanes by reacting silicon, characterized in that a silicon is used which contains homogeneously distributed copper silicide.

The method according to the invention is mainly characterized in that the linkage of copper in the silicon prevents that fine copper dust is carried out of the reactor during a reaction occurring in the fluidized bed, thus requiring replacement of copper during the reaction, like this is the case when conventional copper catalyst is used. Thus the yield of chlorosilane remains largely constant during the reaction.

Another advantage consists in that the step of mixing catalyst and silicon required when using conventional catalyst is not necessary. The advantage for the production plant for the manufacture of chlorosilanes is that neither apparatuses for mixing catalyst and silicon nor silos for catalyst storage are required. This reduces investment expenditure and staff costs and enables a less expensive production.

The silicon to be employed according to the invention can be produced, for example, by melting a mixture consisting of silicon and the desired amount of copper, or by adding the desired amount of copper to a silicon melt, and subsequently cooling down the melt quickly. Preferably the desired amount of copper is added already during the production of the silicon.

The quick cooling of the melt can be achieved, for example, by spraying the melt in air or by water granulation.

It is preferred to use water granulation for the quick cooling of the melted silicon and manufacture of the silicon to be employed according to the invention. For water granulation, liquid silicon is introduced into water. This allows an extremely quick cooling of the silicon. Depending on the process parameters selected, it is possible, for example, to obtain silicon pellets. Water granulation of silicon is known, for example, from EP 522 844 A2.

In this case copper is usually provided in the silicon as homogeneously distributed copper silicide.

Preferably, the silicon used has a concentration of 0.5 to 10 weight percent, particularly preferred of 1 to 5 weight percent, copper in form of homogeneously distributed copper silicide. It is also possible, however, to use silicon with a higher copper concentration.

The method according to the invention can be carried out, for example, at a pressure of 1 to 40 bar (absolute), preferably of 20 to 35 bar.

The process is carried out, for example, at temperatures from 400 to 800° C., preferably from 450 to 600° C.

The selection of the reactor for the reaction according to the invention is not critical, provided that under the reaction conditions the reactor shows adequate stability and permits the contact of the starting materials. The process can be carried out, for example, in a fixed bed reactor, a rotary tubular kiln or a fluidized-bed reactor. It is preferred to carry out the reaction in a fluidized-bed reactor.

On principle, it is possible for the method according to the invention to add an additional catalyst or promoter. Due to the fact, however, that the silicon to be employed according to the invention shows a sufficiently high catalytic activity, it is preferred to carry out the method according to the invention without adding additional catalyst.

Applying the method according to the invention, it is possible to obtain alkyl and aryl chlorosilanes and trichlorosilanes. To produce alkyl and aryl chlorosilanes, the silicon to be employed according to the invention containing homogeneously distributed copper silicide is reacted with alkyl and/or aryl chloride. Thus alkyl or aryl chlorsilanes are accessible, for example, which have one, two or even three alkyl or aryl radicals bound at the silicon. Such alkyl radicals are, for example, C₁-C₈ alkyl, preferably methyl, ethyl, propyl or isopropyl, particularly preferred methyl, the aryl radicals C₆-C₁₀ aryl, preferably phenyl.

The method according to the invention is used, for example, for the manufacture of trichloromethyl silane H₃C-SiCl₃, dichlorodimethyl silane (H₃C)₂-SiCl₂, chlorotrimethyl silane (H₃C)₃—SiCl, trichlorophenyl silane H₅C₆—SiCl₃, dichlorodiphenyl silane (H₅C₆)₂—SiCl₂ and chlorotriphenyl silane (H₅C₆)₃—SiCl.

Preferably the method according to the invention is used for the manufacture of trichlorosilane. To this end, the silicon to be employed according to the invention containing homogeneously distributed copper silicide is reacted with hydrogen, silicon tetrachloride and, if necessary, hydrogen chloride.

The mol ratio of hydrogen to silicon tetrachloride in the reaction according to the invention of silicon containing homogeneously distributed copper silicide with hydrogen, silicon tetrachloride and, if necessary, hydrogen chloride, can be for example 0.25:1 to 4:1. A mol ratio of 0.6:1 to 2:1 is preferred.

When manufacturing trichlorosilane according to the invention, hydrogen chloride can be added, and the amounts of hydrogen chloride can be varied over a wide range. Preferably an amount of hydrogen chloride is added such that a mol ratio of silicon tetrachloride to hydrogen chloride of 1:0 to 1:10, particularly preferred of 1:0.5 to 1:1, is obtained.

Preferably the method according to the invention is carried out in the presence of hydrogen chloride.

Compared with a reaction using copper catalyst, the manufacture of trichlorosilane according to the invention using silicon containing homogeneously distributed copper silicide, has comparable results in terms of yield and time until the stationary state of the reaction is reached. Thus using the method according to the invention provides nearly the same yield, but has the said advantages compared with a method using copper catalyst.

Trichlorosilane produced according to the method according to the invention can be used, for example, for the manufacture of silane and/or hyper-pure silicon.

Therefore the invention also relates to a method for producing silane and/or hyper-pure silicon on the basis of trichlorosilane obtained according to the method specified above.

Preferably the method according to the invention is integrated into a general method for producing silane and/or hyper-pure silicon.

Particularly preferred, the method according to the invention is integrated into a multistage general method for producing hyper-pure silicon, as specified for example in “Economics of Polysilicon Process, Osaka Titanium Co., DOE/JPL 1012122 (1985), 57-78” and comprising the following steps:
a) Production of trichlorosilane;
b) Disproportionation of trichlorosilane to yield silane;
c) Purifying silane to obtain high-purity silane; and
d) Thermal decomposition of silane in a fluidized-bed reactor and depositing of hyper-pure silicon on the silicon particles which form the fluidized bed.

The method according to the invention is being explained in more detail in the following examples, without restricting the inventive idea insofar.

### EXAMPLES

### Example 1 (Comparative Example)

In a reactor consisting of a glass tube with a diameter of 3 cm and a height of 18 cm and an in-built glass frit, silicon of the grain size fraction of 160-200 μm was mixed with cuprous chloride. Subsequently the mixture contained 3 weight percent copper. 40 g of this mixture were heated to 500° C. and agitated by a helical ribbon impeller. A gas mixture of hydrogen and silicon tetrachloride with a mol ratio of 1.85:1 was now led through this charge from below. The gas velocity was 2.85 cm/s, with a residence time of the gas mixture in the silicon charge of 1.7 s. The reaction occurred at a pressure of 1 bar (absolute). After 30 min the yield of trichlorosilane amounted to approx. 5%, based on the amount of silicon tetrachloride employed; it decreased to 0.4% after another 30 min and then remained constant.

### Example 2

In a reactor consisting of a glass tube with a diameter of 3 cm and a height of 18 cm and an in-built glass frit, 40 g water granulated silicon of the grain size fraction of 160-200 μm with a percentage of finely distributed copper of 1 weight percent was used. This silicon was heated to 500° C. and agitated by a helical ribbon impeller. A gas mixture of hydrogen and silicon tetrachloride with a mol ratio of 1.85:1 was now led through this charge from below. The gas velocity was 2.85 cm/s, with a residence time of the gas mixture in the silicon charge of 1.7 s. The reaction occurred at a pressure of 1 bar (absolute). The yield of trichlorosilane amounted to 12.8 12.8% based on the silicon tetrachloride used. The stationary state was achieved after a period of approx. 60 min.

1. A method for producing chlorosilanes by reacting silicon, wherein the silicon used contains homogeneously distributed copper silicide such that copper is linked in the silicon.

2. A method according to claim 1, wherein the silicon used is produced by means of water granulation.

3. A method according to claim 1, wherein the silicon has a concentration of 0.5 to 10 weight percent copper.

4. A method according to claim 1, wherein the silicon has a concentration of 1 to 5 weight percent copper.

5. A method according to claim 1, wherein silicon is reacted with at least one of alkyl and aryl halides to at least one of alkyl and aryl halosilane.

6. A method according to claim 1, wherein silicon is reacted with hydrogen and silicon tetrachloride to form trichlorosilane.

7. A method according to claim 6, wherein the reaction is carried out at a pressure of 1 to 40 bar (absolute).

8. A method according to claim 6, wherein the reaction is carried out at temperatures from 400 to 800° C.

9. A method according to claim 6, wherein the mol ratio of hydrogen to silicon tetrachloride is 0.25:1 to 4:1.

10. A method according to claim 6, wherein the mol ratio of hydrogen to silicon tetrachloride is 1:0 to 1:10.

11. A method for producing at least one of silane and hyper-pure silicon, wherein the starting material is trichlorosilane produced by use of silicon which contains homogeneously distributed copper silicide such that copper is linked in the silicon.

12. A method according to claim 6, wherein silicon is reacted with hydrogen, silicon tetrachloride and hydrogen chloride to form trichlorosilane.
